(19) United States
(12) Patent Application Publication
(10) Pub. No.: US 2025/0267630 A1
(43) Pub. Date: Aug. 21, 2025

(54) METHOD, APPARATUS AND SYSTEM RELATING TO REQUESTING TO USE A FIRST RESOURCE FOR TRANSMITTING A SECOND SIDELINK POSITIONING REFERENCE SIGNAL

(71) Applicant: Nokia Technologies Oy, Espoo (FI)

(72) Inventors: Prajwal KESHAVAMURTHY, Munich (DE); Berthold PANZNER, Munich (DE); Taylan SAHIN, Munich (DE); Stepan KUCERA, Munich (DE); Diomidis MICHALOPOULOS, Munich (DE)

(21) Appl. No.: 18/857,781

(22) PCT Filed: Apr. 28, 2022
(86) PCT No.: PCT/EP2022/061414

§ 371 Date: Oct. 17, 2024

(51) Int. Cl. H04W 72/044; H04L 5/00; H04W 72/25

(52) U.S. Cl. CPC H04W 72/044; H04L 5/0051; H04W 72/25

(57) ABSTRACT

A method, e.g. performed by a first apparatus, is disclosed, the method comprising: transmitting a request message requesting to use at least part of one or more first resources that are designated for transmission of one or more first sidelink positioning reference signals for transmitting a second sidelink positioning reference signal; and observing a reaction to the request message; and determining, based on the observed reaction, whether use of the at least part of the one or more first resources is accepted for transmitting the second sidelink positioning reference signal. A corresponding first apparatus and computer program are disclosed. Further, a corresponding method for a second apparatus, a second apparatus, a second computer program and a system are disclosed.

### TECHNICAL FIELD

Various example embodiments relate to requesting to use at least part of one or more first resources that are designated for transmission of one or more first sidelink positioning reference signals for transmitting a second sidelink positioning reference signal.

### BACKGROUND

Sidelink positioning is based on transmission of one or more sidelink positioning reference signals (SL-PRSs) by one or more anchor user equipments (UEs) to be received by a target UE (or a SL-PRS exchange between the anchor and one or more target UEs) to enable localization of the target UE(s) (e.g. via triangulation) within predetermined latency and accuracy requirements of the corresponding SL positioning session. SL positioning may enable many use cases, most prominently public safety and vehicular applications as well as industrial and commercial applications.

### SUMMARY OF SOME EXAMPLE EMBODIMENTS

Positioning reference signals, e.g., SL-PRSs, may be designed based on, e.g., orthogonal, code, sequences (e.g. Zadoff-Chu sequences with cyclic shifts). The length of a sequence may be determined to meet positioning accuracy requirements. To allow for high accuracy positioning, it may be required for a SL-PRS to be a wide-band signal that spans contiguously over potentially very large bandwidth or even multiple frequency bands. In various examples, the entire usable bandwidth may be used in an attempt to meet accuracy requirements.

It may be beneficial if the SL-PRS transmissions by multiple anchor UEs can ensure that the SL-PRSs do not interfere with each other and that they are distinguishable by the target UE(s). Therefore, the code-time-frequency resource allocation (RA) for SL-PRS may play a key role in enabling SL positioning to meet latency and accuracy requirements.

Resource allocation may be done according to various modes. For example, according to mode 1 (e.g., 5G NR SL Mode-1), SL radio resources may be assigned by a (e.g. central) network node, e.g., a gNB, eNB or any other base station. Using mode 1 may require that a respective UE is in network coverage.

In contrast, in mode 2, e.g. 5G NR SL Mode-2, a UE may autonomously select SL transmission resources (time-frequency), e.g., in SL a transmission resource pool. The selection may be done based on (full or partial) sensing (e.g., monitoring resource reservation indicated in SCI and/or SL-RSRP) or random resource selection. Mode 2 may be particularly used in out-of-coverage (0° C.) scenarios. It may allow for one or more nearby UEs to select non-overlapping time-frequency resources to reduce mutual interference. Consequently, when mode 2 is used for SL-PRS transmissions, one or more nearby anchor UEs may select non-overlapping time-frequency resources for SL-PRS transmissions. However, since the SL-PRSs may be wide-band signals, this may increase the channel congestion, and a few SL-PRS transmissions may already significantly increase the channel busy ratio (CBR). In some scenarios, this may adversely impact reliability and/or latency of SL-PRS and SL PSCCH/PSSCH (in case of shared pool) transmissions.

To improve the resource utilization efficiency and/or to reduce SL channel congestion, multiple SL-PRS transmissions may be multiplexed in code domain using the same time-frequency resources since the SL-PRS is a sequence/code. However, the number of SL-PRSs may be limited. Further, in mode 2 there may be no central entity that assigns code-time-frequency SL-PRS transmission resources. Consequently, the SINR (Signal-to-Interference-plus-Noise-Ratio) performance and/or decoding performance of SL-PRS may, in some scenarios, be significantly degraded at the respective target UE(s) when multiple anchor UEs select the same time-frequency resources (e.g. with an aim to increase channel utilization) for their SL-PRS sequences transmission that may be non-orthogonal at the target UEs. Such degradation might in turn, in some scenarios, significantly affect the quality (e.g. accuracy, delay, etc.) of positioning measurements (based on time, power, etc. over SL-PRS), hence as a result, the accuracy of location information to be estimated.

Hence, a scheme may be beneficial that enables one or more anchor UEs to aim for aggregation (or multiplexing) of their SL-PRS transmissions to increase resource utilization while attempting to meet the accuracy (in terms of SINR and/or distinguishability/detectability of SL-PRS transmissions) requirements at one or more target UEs.

An example of such a scheme may be based on, e.g. an anchor UE, requesting to use at least part of one or more first resources that are designated for transmission of one or more first SL-PRSs for transmitting a second SL-PRS. Another apparatus, e.g., a target UE, may determine whether use of the at least part of the one or more first resources is acceptable for transmitting a second SL-PRS.

In the following, various example aspects and embodiments will be described using the following abbreviations:
3GPP 3rd Generation Partnership Project
ACK Acknowledgment
AGC Automatic Gain Control
CBR Channel Busy Ratio
DMRS Demodulation Reference Signal
eNB Evolved NodeB (LTE Base Station)
FB Feedback
gNB Next Generation NodeB (NR Base Station)
HARQ Hybrid Automatic Repeat Request
ID Identifier
IIoT Industrial Internet of Things
LCS Location Services
MAC Medium Access Control
NACK Non (or Negative)-acknowledgement
NR New Radio
OoC Out-of-Coverage
PSCCH Physical Sidelink Control Channel
PSFCH Physical Sidelink Feedback Channel
PSSCH Physical Sidelink Shared Channel
RSRP Reference Signal Received Power
RSU Road-Side Unit
SCI Sidelink Control Information
SINR Signal-to-Interference-Plus-Noise-Ratio
SL Sidelink
SPS Semi-Persistent Scheduling
PRS Positioning Reference Signal
RA Resource Allocation
V2X Vehicle-to-anything
UE User Equipment

Furthermore, the following example terminology may be used to describe aspects of SL positioning. However, other terminologies are possible.

“Target UE” may refer to a UE to be positioned.

“Anchor UE” may refer to a UE supporting positioning of a target UE, e.g., by transmitting and/or receiving reference signals for positioning, e.g., over SL interface. Anchor UEs may have a function similar to those of gNBs in UL/DL-based positioning, where gNBs may serve as anchors transmitting and/or receiving reference signals to/from target UEs for positioning.

“Sidelink Positioning Reference Signal (SL-PRS)” may refer to a reference signal transmitted over SL for positioning purposes.

“SL-PRS (pre-) configuration” may be a term that refers to one or more (pre-) configured parameters of SL-PRS such as time-frequency resources comprising, e.g., its bandwidth and/or periodicity; directivity-related parameters, e.g., beam direction, beam width, number of beams; and/or transmit power. There may be further parameters.

“In-coverage (scenario)” may refer to a case where both UEs (e.g. anchor UE, target UE) are inside the network.

“Partial coverage (scenario)” may mean that one UE of both UEs (e.g. anchor UE, target UE) remains inside the network coverage but the other UE is outside the network coverage. In-coverage or partial coverage may be determined by network, e.g., by Location Management Function (LMF), or gNB.

“Out-of-coverage (scenario)” may refer to the case where both UEs (e.g. anchor UE, target UE) are outside the network coverage. The condition of the Out-of-coverage could be pre-configured and/or determined by one or more UEs autonomously.

A UE may transit between in-coverage, partial coverage and out-of-coverage scenarios.

“Road-Side Unit (RSU)” may refer to a UE-type and/or gNB-type stationary infrastructure entity, e.g., supporting V2X applications.

“Absolute positioning” may refer to estimating the UE's position in 2D and/or 3D coordinates within a coordinate system, for example using geographic coordinates (e.g., latitude, longitude, and/or elevation).

“Relative positioning” may refer to estimating a position relatively to other network elements and/or relatively to other UEs.

“Ranging” may refer to a determination of the distance between two UEs and/or the direction of one UE from the other one, e.g., via direct device connection.

Various example aspects and embodiments will now be described. It will be understood that any feature presented for an example embodiment in a particular category (e.g. method/apparatus/computer program/system) may also be used or be a part in a corresponding manner in an example embodiment of any other category.

According to a first example aspect, a first apparatus is disclosed. The first apparatus may be a UE, e.g., an anchor UE. The first apparatus comprises means for:
transmitting a request message requesting to use at least part of one or more first resources that are designated for transmission of one or more first sidelink positioning reference signals for transmitting a second sidelink positioning reference signal; and
observing a reaction to the request message; and
determining, based on the observed reaction, whether use of the at least part of the one or more first resources is accepted for transmitting the second sidelink positioning reference signal.

A respective resource of the one or more first resources may be a time, frequency or time-frequency resource. Thus, a respective resource of the one or more first resources may be specified in at least one of time domain or frequency domain. The one or more first resources that are designated for transmission of one or more first SL-PRSs may also be referred to as the one or more first SL-PRS resources.

The one or more first resources may be designated for transmission of the one or more first SL-PRSs in that they have been reserved by a third apparatus for the transmission of the one or more first SL-PRSs, e.g., by a first SL-PRS resource reservation information. The third apparatus may be another anchor UE.

In various embodiments, the first apparatus may further comprise means for:
receiving a first sidelink positioning reference signal resource reservation information indicating reservation of the one or more first resources for transmission of the one or more first sidelink positioning reference signals, wherein the request is transmitted after receiving the first sidelink positioning reference signal resource reservation information.

Thus, the first apparatus may monitor a first SL-PRS resource reservation information for a first SL-PRS transmission from a third apparatus. For example, by monitoring PSCCH, the first apparatus may decode SCI (e.g. 1st stage SCI) from the third apparatus, wherein the SCI contains at least first SL-PRS resource reservation information for the transmission of the one or more first SL-PRSs.

If the first apparatus receives a first SL-PRS resource reservation information indicating the one or more first resources for transmission of the one or more first SL-PRSs, the request message requesting to use at least part of one or more first resources that are designated for transmission of one or more first SL-PRSs for transmitting a second SL-PRS may correspond to requesting to reuse the at least part of the one or more first resources.

In other scenarios, the first apparatus may send a request to use at least part of one or more first SL-PRS resources (e.g. even) when the first SL-PRS resource is not observed to be reserved by a third apparatus. This may be particularly beneficial when the one or more first resources are designated for transmission of one or more first SL-PRSs in that they are dedicated SL-PRS resources (e.g., time slots) spread in time and the second UE may request to use one or more of those dedicated SL-PRS.

The first apparatus may transmit the request message to the second apparatus. Specifically, the first apparatus, which has the second SL-PRS to transmit, may request (from a second apparatus) to use at least a part of first SL-PRS resources for its own SL-PRS transmission. The request relates to whether the first apparatus may use the at least one or more first resources for transmitting the second SL-PRS. It may not relate to whether the second apparatus receiving the request can use the at least one or more first resources for transmitting the second SL-PRS.

In various embodiments of all example aspects, the request message may indicate control information associated with the second SL-PRS. Accordingly, in various embodiments of all example aspects, the control information may indicate information related to the second SL-PRS. For example, the request message may indicate a configuration of the second SL-PRS, e.g., a SL-PRS sequence/code associated with the first apparatus. As the control information may comprise (e.g., part of) a sequence of the second SL-PRS, the control information may indicate the SL-PRS sequence (e.g., of the second SL-PRS) that the first apparatus intends to use in the one or more first resources. Additionally or alternatively, the control information may indicate e.g. one or more SL transmission parameters, e.g. MCS.

In various embodiments of all example aspects, the request message is transmitted according to one or more of the following options:
(i) using a resource that has a pre-configured position relative to the one or more first resources; and/or
(ii) using a resource that is pre-configured; and/or
(iii) using a resource that is designated for transmission of one or more sidelink positioning reference signals; and/or
(iv) using sidelink control information which indicate the at least part of the one or more first resources that are designated for transmission of one or more first sidelink positioning reference signals for which use for transmitting the second sidelink positioning reference signal is requested.

Thus, according to option (i) the request message may be transmitted using a resource that has a pre-configured position relative to the one or more first resources. The pre-configured position relative to the one or more first resources may be specified as a configured offset in terms of e.g. time slots and/or subchannels with respect to the one or more first SL-PRS resources. By transmitting (e.g. a part of an initial SL-PRS) in a resource which is offset from the first SL-PRS resource as per the configuration, the first apparatus may send, e.g., broadcast, the request message to use at least a part of the one or more first resources designated for transmission of one or more first SL-PRSs for transmitting a second SL-PRS. The part of the initial SL-PRS may be based on and/or indicate the second SL-PRS. It may be associated with the first apparatus.

According to option (ii) the request message may be transmitted using a resource that is pre-configured. In particular, a time-frequency resource may be used that is configured in association with the occurrence of one or more first SL-PRS resources for requesting transmission of a second SL-PRS. Accordingly, one or more first apparatuses that intend to use the one or more first SL-PRS resources for transmitting a respective second SL-PRS may send at least a part of their respective SL-PRS sequence in the configured resource to send their request to use the first SL-PRS resource.

According to option (iii), the request message may be transmitted using a resource that is designated for transmission of one or more SL-PRSs. The resource may be designated for transmission of, e.g. one of, the one or more first SL-PRSs. The first apparatus may transmit (e.g., a part of an SL-PRS sequence) in the part of the SL-PRS resource to convey its request to use the SL-PRS, e.g. in SPS manner, e.g. from the next periodic occurrence of the SL-PRS resource. The part of the SL-PRS may be based on and/or indicate the second SL-PRS for which the respective first apparatus requests use of the one or more first resources.

According to option (iv), the request message may be transmitted using SCI which may indicate the at least part of the one or more first resources that are designated for transmission of one or more first SL-PRSs for which use for transmitting the second SL-PRS is requested. For example, the request message may be transmitted using an SCI by indicating the time-frequency-code resource of the one or more first SL-PRS resources. The first apparatus may indicate in its SCI how to differentiate between the first SL-PRS and the second SL-PRS transmission in code domain. For example, the SCI may indicate the code used for the second SL-PRS transmission.

According to a second example aspect, a second apparatus is disclosed. The second apparatus may be a UE, e.g. a target UE. The second apparatus comprises means for:
receiving a request message requesting to use at least part of one or more first resources that are designated for transmission of one or more first sidelink positioning reference signals for transmitting a second sidelink positioning reference signal;
determining, based on one or more predetermined parameters, whether use of the at least part of the one or more first resources is acceptable for transmitting the second sidelink positioning reference signal; and
performing a reaction to the request message.

The second apparatus may receive the request message according to one of the ways described above for the transmission of the request message.

The second apparatus may determine, based on the request message and the one or more predetermined parameters, whether use of the at least part of the one or more first resources is acceptable for transmitting the second SL-PRS. This may comprise that the second apparatus estimates whether it can successfully receive in the one or more first SL-PRS resources the one or more first SL-PRS transmissions and/or the second SL-PRS transmission. Thus, for example, if it estimates that it can successfully receive the first and/or second SL-PRS transmissions, it may consider the usage of the one or more first SL-PRS resources by the second UE for transmitting the second SL-PRS acceptable. The second apparatus may be the intended recipient for the one or more first SL-PRS transmissions and/or for the second SL-PRS transmission.

In various embodiments of all example aspects, the one or more predetermined parameters based on which the determining is done may comprise and/or be based on one or more of:
(i) a rate of past successful transmissions from a first apparatus and/or from a third apparatus, the first apparatus requesting to use the at least part of the one or more first resources for transmitting the second sidelink positioning reference signal, the third apparatus transmitting the one or more first sidelink positioning reference signals; and/or
(ii) an indicator for a link quality between the first apparatus and the second apparatus and/or between the third apparatus and the second apparatus, e.g., SINR measured in SCI; and/or
(iii) information indicating a proximity between the first apparatus and the second apparatus and/or the third apparatus and the second apparatus, e.g., a first fix of a ranging measurement based on SL received power; and/or
(iv) control information indicated by the first apparatus and/or the third apparatus, e.g., MCS of one or both transmissions.

The second apparatus may perform a reaction to the request message based on an outcome of the determining whether use of the at least part of the one or more first resources is acceptable for transmitting the second SL-PRS.

In various embodiments of all example aspects, the reaction to the request message indicates whether use of at least part of the one or more first resources that are designated for the transmission of one or more first SL-PRSs for transmitting the second SL-PRS is accepted. It may be sufficient if the first apparatus can determine (e.g. derive) whether use of at least part of the one or more first resources is accepted. For example, the reaction to the request message may indicate to the first apparatus whether use of at least part of the one or more first resources is accepted. Accordingly, the reaction may be based on a predetermined protocol known to the first and the second apparatus.

In various embodiments of all example aspects, the reaction indicates that the requesting is denied if it corresponds to a denial response being transmitted. The denial response may be a NACK. It may be transmitted on one or more PSFCH resources. The second apparatus may transmit the denial response and the first apparatus may receive the denial response when observing the reaction to its request message. For example, the second apparatus may send a NACK in a PSFCH resource to indicate its disapproval or rejection of the request if it finds the usage of the first SL-PRS resource by the first apparatus for transmitting the second SL-PRS unacceptable. The second apparatus may send the NACK to the first apparatus.

In various embodiments, the reaction indicates that the requesting is accepted if it corresponds to no response (e.g. no ACK or NACK, or no explicit message is provided) to the request message being transmitted in one or more resources that are used for the reaction to the request. The one or more resources may be PSFCH resources. The one or more resources may be determinable for both the first and the second apparatus. The second apparatus may determine not to use them for a response to the request message as reaction to the request message. The first apparatus may observe the resources when observing a reaction to the request. Consequently, the first apparatus may observe that the resources are not used by the second apparatus for a response to the request message. It may interpret this as meaning that the requesting is accepted. This type of reaction to indicate acceptance may be referred to as “implicit acceptance”.

In various embodiments of all example aspects, the reaction indicates that the requesting is accepted if it corresponds to an acceptance response being transmitted. Thus, the second apparatus may transmit an acceptance response to the first apparatus to indicate that the requesting is accepted. The acceptance response may be an ACK. It may be transmitted on one or more PSFCH resources.

In various embodiments of all example aspects, the reaction indicates that the requesting is partly denied if it corresponds to a response being transmitted indicating a part of the one or more first resources for which use is denied (or accepted). For example, when the first apparatus requests to use multiple first SL-PRS resources, ACK, NACK and/or a combination of ACK/NACK sequences (e.g., ACK/NACK code combination) may be used by the second apparatus to indicate usage of which of the first SL-PRS resources is unacceptable (or rejected). The response may be transmitted on one or more PSFCH resources.

In various embodiments of all example aspects, the second apparatus may receive a plurality of request messages, e.g. from a respective plurality of first apparatuses, respectively requesting to use at least part of the one or more first resources that are designated for transmission of the one or more first sidelink positioning reference signals for transmitting a respective second sidelink positioning reference signal, and the reaction to the request message may be configurable to indicate that a subset of the plurality of requests is denied and to indicate that another subset of the plurality of requests is accepted. Thus, the second apparatus may be able to selectively accept and/or deny requests of the plurality of requests. The reaction may be a single reaction. It may comprise or consist of a ACK/NACK code combination. For example, different ACK/NACK code combinations may be used for indicating different responses, respectively. The response may be transmitted on one or more PSFCH resources.

Additionally or alternatively, the reaction to the request is associated with one or more PSFCH resources which are used for performing and observing the reaction. For example, the second apparatus may respond to the request of the first apparatus on PSFCH resource(s) to indicate whether the second SL-PRS transmission on at least a part of the one or more first SL-PRS resources is acceptable (e.g., whether request is accepted or rejected) or not.

In various embodiments of all example aspects, the first and/or second apparatus may comprise means for:
determining one or more physical sidelink feedback channel resources that are used for the reaction to the request message.

The determining may be done based on information from the network. For example, a PSFCH resource may be configured e.g. by the network for indication from the second apparatus. Additionally or alternatively, the PSFCH resource may be associated (e.g., with fixed time offset) with the resource in which the first apparatus sends the request to use the first SL-PRS resource. The second apparatus may use the PSFCH resource to indicate whether usage of the first SL-PRS resource by the first apparatus (e.g., according to the request) is acceptable or not, e.g. while the first apparatus monitors the PSFCH resource.

The first and/or second apparatus may determine the one or more PSFCH resources for the reaction by mapping the PSFCH resources using the one or more resources in which the request message is sent from the first apparatus and the L1 ID of the first apparatus. This determination of one or more PSFCH resources may use a mapping rule similar to that described in 3GPP Release 16 TS 38.213 for HARQ feedback. This may be surprising given that reacting to a request message requesting to use resources is very different from the original application of HARQ feedback. According to various embodiments, an intended recipient sends a feedback indication or provides a reaction to another UE that would like to (re)use resources in the future. Thus, the reaction is related to resource allocation. In contrast, in conventional SL HARQ feedback procedures feedback is sent by a receiver UE to a transmitter UE that has already transmitted information to the receiver UE. Here, such a feedback is not sent back to a transmitter UE to indicate a reception status regarding previously transmitted information.

Specifically, in order to ensure the reliability of SL transmission, hybrid automatic repeat request (HARQ) feedback schemes have been designed in SL unicast and groupcast, such that the SL transmitter (Tx) user equipment (UE) can be aware of the reception status at an intended receiver (Rx) UE. In other words, after the SL Tx UE transmits a sidelink control information (SCI) and the corresponding data payload over the selected/allocated physical sidelink control channel (PSCCH)/physical sidelink shared channel (PSSCH) resources, an intended SL Rx UE may indicate its reception status over a PSFCH resource associated to that PSCCH/PSSCH resources. The mapping between a PSCCH/PSSCH transmission/reception and the corresponding PSFCH resource is specified in section 16.3 of TS 38.213, such that both the SL Tx UE and the intended SL Rx UE(s) can determine the PSFCH resource(s) used for the HARQ feedback(s). In case HARQ-feedback is enabled:

In SL groupcast HARQ option 1 (also known as “negative-only acknowledgement”, e.g. in TS 38.321), a SL Rx UE within a range of the SL Tx UE may send only a negative-acknowledgement (NACK) feedback if it successfully decodes the sidelink control information (SCI) but fails in decoding the data payload. It is noted that this approach may be referred to as “negative-only acknowledgement” in NR medium access control (MAC) specification TS 38.321. Otherwise, the SL Rx UE may refrain from transmitting any feedback. In this option, the different SL Rx UEs sending NACK may use a common/shared PSFCH resource. The common/shared PSFCH resource can be determined by SL Rx UEs and the SL Tx UE by considering (i) the starting-subchannel or subchannels and the slot used for the associated PSSCH transmissions, which may depend on the configuration contained in sl-PSFCH-CandidateResourceType; and (ii) the Layer-1 (L1) source identifier (ID) provided by the SCI.

In SL unicast and SL groupcast HARQ option 2 (also known as “negative-positive acknowledgement”, e.g. in TS 38.321), a SL Rx UE may send either acknowledgement (ACK) (e.g. if it has received successfully the PSCCH and PSSCH) or NACK (e.g. if it successfully decodes the SCI but fails in decoding the data payload) or nothing (e.g. if it does not decode the SCI). It is noted that this approach is also referred to as “negative-positive acknowledgement” in NR MAC specification TS 38.321. In this option, an intended SL Rx UE may send its feedback over a dedicated PSFCH resource, i.e. UE-specific PSFCH resource.

For SL unicast, since there is only one SL Rx UE, the PSFCH resource can be determined by the SL Rx UE and the SL Tx UE by considering the same information as for SL groupcast HARQ option 1, i.e. (i) the starting-subchannel or subchannels and the slot used for the associated PSSCH transmissions; and (ii) the Layer-1 (L1) source ID provided by the SCI.

In SL groupcast HARQ option 2, in order to determine the dedicated PSFCH resource used by each intended SL Rx UE in the group, besides the information possibly needed and listed before for HARQ option 1, a SL Rx UE may also need to use its group member ID obtained from higher layers, wherein the ID should be a unique ID in the considered group. Thus, the unique group member ID of each Rx UE may ensure a dedicated PSFCH resource for each Rx UE to send its HARQ feedback. Accordingly, the SL Tx UE may use the same logic to derive the PSFCH resource. For example, according to TS 38.213, the dedicated PSFCH resource for an intended Rx UE may be determined by using modulo operation by considering the L1 source ID provided by the received SCI and its group member ID provided by higher layers:

A UE determines an index of a PSFCH resource for a PSFCH transmission in response to a PSSCH reception as (P_{ID}+M_{ID}) mod R_{PRB,CS}^{PSFCH} where P_{ID} is a physical layer source ID provided by SCI format 2-A or 2-B scheduling the PSSCH reception, and M_{ID} is the identity of the UE receiving the PSSCH as indicated by higher layers if the UE detects a SCI format 2-A with Cast type indicator field value of “01”; otherwise, M_{ID} is zero.

It is noted that SL groupcast HARQ option-2 may allow for multiplexing of Zadoff-Chu sequence-based HARQ feedback from member UEs with a sequence with a different cyclic shift per group member UE, as mentioned above. Thus, a distinct sequence may be pre-assigned to each member UE for HARQ FB transmission based on the member ID. Also, a PSFCH resource (in which HARQ FB may be transmitted) may be mapped to the respective PSCCH/PSSCH transmission resource, and hence the resource for sequence transmission may be pre-assigned (i.e., derived based on the PSCCH/PSSCH transmission from the Tx UE of the group).

In various embodiments of all example aspects, such a SL HARQ procedure for determining PSFCH resource may be reused for providing feedback from the target UE to the anchor UE on whether anchor UE can use certain SL-PRS resource or not. For example, the first and/or second apparatus may determine an index of a PSFCH resource for a reaction, e.g., a PSFCH (response) transmission, in response to the request reception as (P_{ID}+M_{ID}) modR_{PRB,CS}^{PSFCH} where P_{ID} is a physical layer/L1 source ID provided by SCI, and M_{ID} can be set as 0. R_{PRB,CS}^{PSFCH} may be the number of PSFCH resources available for multiplexing HARQ-ACK information in a PSFCH transmission. The reuse may be configured on a different PSFCH resource pool than the traditional SL HARQ feedback. Consequently, it may be possible to avoid overlap with the PSFCH resources meant for traditional SL HARQ feedback.

Based on the observed reaction, the first apparatus may determine whether use of the at least part of the one or more first resources is accepted for transmitting the second SL-PRS. For example, if the second apparatus indicates that the usage of the one or more first SL-PRS resources by the first apparatus for transmitting the second SL-PRS is unacceptable, e.g., by sending a denial response in PSFCH resource (e.g. a NACK), the first apparatus may determine not to use the at least part of the one or more first SL-PRS resource. Otherwise, it may use the at least part of the first SL-PRS resources for transmitting the second SL-PRS. This may increase the resource utilization.

Thus, in some embodiments of all example aspects, the first apparatus may further comprise means for:
if it has been determined that the use is accepted, transmitting the second sidelink positioning reference signal using the at least part of the one or more first resources.

In some embodiments of all example aspects, the one or more first SL-PRSs are transmitted using a first code in a code domain and the second SL-PRS is transmitted using a second code in the code domain. The first and the second code may be different, e.g. orthogonal. Thus, the second sidelink positioning reference signal may be transmitted using a code in code-domain that is different from, e.g. orthogonal to, a code used for the transmission of the one or more first SL-PRSs. This may allow the second apparatus to distinguish the one of more first SL-PRSs and the second SL-PRS, even though they are transmitted using the at least partly the same time-frequency resources. As described before, the sequence/code used for transmitting the second SL-PRS may have been indicated, e.g. by the request message, e.g. as at least part of control information associated with the second SL-PRS.

In some embodiments of all example aspects, the first code and the second code may be the same. For example in scenarios where the transmitter of the one or more first SL-PRSs is identified and/or estimated to be, e.g. significantly, far from the first apparatus, the first apparatus may determine to use the same code as the transmitter of the one or more first SL-PRSs. Thus, in such example scenarios, the second code may be the same as the first code. Particularly in this case, the first apparatus may be considered to, e.g. explicitly, indicate the usage of the second code in the request message.

The second apparatus may receive the second SL-PRS. It may use it for positioning.

Positioning requirements may be captured via indicators, e.g., key-performance-indices (KPIs), such as:
horizontal and vertical accuracy, where vertical accuracy may refer to accuracy in altitude and may determine the floor for indoor use cases and/or may distinguish between superposed tracks for road and rail use cases (e.g. bridges);
positioning service availability which may refer to a percentage value of the amount of time the positioning service is delivering the required position-related data within the performance requirements, divided by the amount of time the system is expected to deliver the positioning service according to the specification in the targeted service area;
positioning service latency which may refer to time elapsed between the event that triggers the determination of the position-related data and the availability of the position-related data at the system interface;
time to first fix (TTFF) which may refer to time elapsed between the event triggering for the first time the determination of the position-related data and the availability of the position-related data at the positioning system interface;
update rate; and/or
energy consumption.

Other indicators may be used in addition or in the alternative.

Performance requirements may be different for different positioning service levels. For example, along with horizontal and vertical accuracy requirements, the requirements on positioning service availability and positioning service latency may be particularly stringent for positioning service levels 4 (e.g., 99.9% availability and 15 ms latency) and 6 (e.g., 99.9% availability and 10 ms latency). Examples of scenarios/use cases of positioning service levels 4 and 6 include:
V2X, set-2 and set-3 use cases: This corresponds to scenarios such as vehicle platooning, cooperative lane merge, lane change warning, emergency break warning, intersection movement assist, etc., and use cases such as high definition sensor sharing, vulnerable road user (VRU)-collision risk warning, cooperative manoeuvers in emergency situations, real-time situation awareness and high-definition maps, etc.
Industrial Internet of Things (IIoT): Factories of the Future scenarios such as augmented reality in smart factories, mobile control panels with safety functions in smart factories (within factory danger zones), inbound logistics for manufacturing (for driving trajectories (if supported by further sensors like camera, GNSS, IMU) of indoor autonomous driving systems)).

The following shall be disclosed for each of the above-described two aspects, respectively:

(1) A method comprising steps corresponding to the functionality of the means in the first or second apparatus.

(2) An apparatus or system configured to perform and/or control or comprising respective means for performing and/or controlling the method according to the respective aspect.

The means of the apparatus or system can be implemented in hardware and/or software. They may comprise for instance at least one processor for executing computer program code for performing the required function, at least one memory storing the program code and/or data, or both. Alternatively, they could comprise for instance circuitry that is designed to implement the required functions, for instance implemented in a chipset or a chip, like an integrated circuit. In general, the means may comprise for instance one or more processing means or processors.

(3) An apparatus or system (that in particular comprises at least two apparatuses) comprising at least one processor and at least one memory including computer program code, the at least one memory and the computer program code configured to, with the at least one processor, cause an apparatus or system (e.g. the apparatus or the system) at least to perform and/or control the method according to the respective aspect.

The disclosed apparatus performing the method according to the respective aspect may comprise only the disclosed components (e.g. means, processor, memory) or may further comprise one or more additional components.

(4) A computer program when executed by a processor causing an apparatus (e.g. a server or a tracking device) to perform and/or control the actions and/or steps of the method according to the respective aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory (e.g. a Read-Only Memory (ROM) or hard disk of a computer, or be intended for distribution of the program, like an optical disc).

(5) A tangible, non-transitory computer-readable medium storing a computer program code, the computer program code when executed by a processor causing an apparatus to perform and/or control the method according to the respective aspect.

Some example embodiments will now be described with reference to the accompanying drawings. It is to be understood, however, that the drawings are designed solely for purposes of illustration and only serve as non-limiting examples. It should be further understood that the drawings are not drawn to scale and that they are merely intended to conceptually illustrate the structures and procedures described herein.

### BRIEF DESCRIPTION OF THE FIGURES

It is shown in:

FIG. 1 an example overview of different SL positioning scenarios for vehicle-to-anything (V2X) and public safety applications;

FIG. 2 a schematic diagram of a system according to an example embodiment;

FIG. 3 transmissions and actions performed by apparatuses according to example embodiments;

FIG. 4 an illustration of using a resource for a request message that has a pre-configured position relative to the one or more first resources according to an example embodiment;

FIG. 5 an illustration of using a pre-configured resource for a request message according to an example embodiment;

FIG. 6 an illustration of using a resource that is designated for transmission of one or more sidelink positioning reference signals for a request message according to an example embodiment;

FIG. 7 an example of a PSCCH/PSSCH slot in which a PSFCH is sent in one symbol among the last SL symbols;

FIG. 8 transmissions and actions performed by apparatuses according to example embodiments, wherein by way of example two apparatuses respectively perform an embodiment of the method according to the second aspect;

FIG. 9 a schematic block diagram of an apparatus according to an example embodiment of the first or second aspect;

FIG. 10 a flowchart of an example embodiment of a method according to the first example aspect; and

FIG. 11 a flowchart of an example embodiment of a method according to the second example aspect.

### DETAILED DESCRIPTION OF EXAMPLE EMBODIMENTS

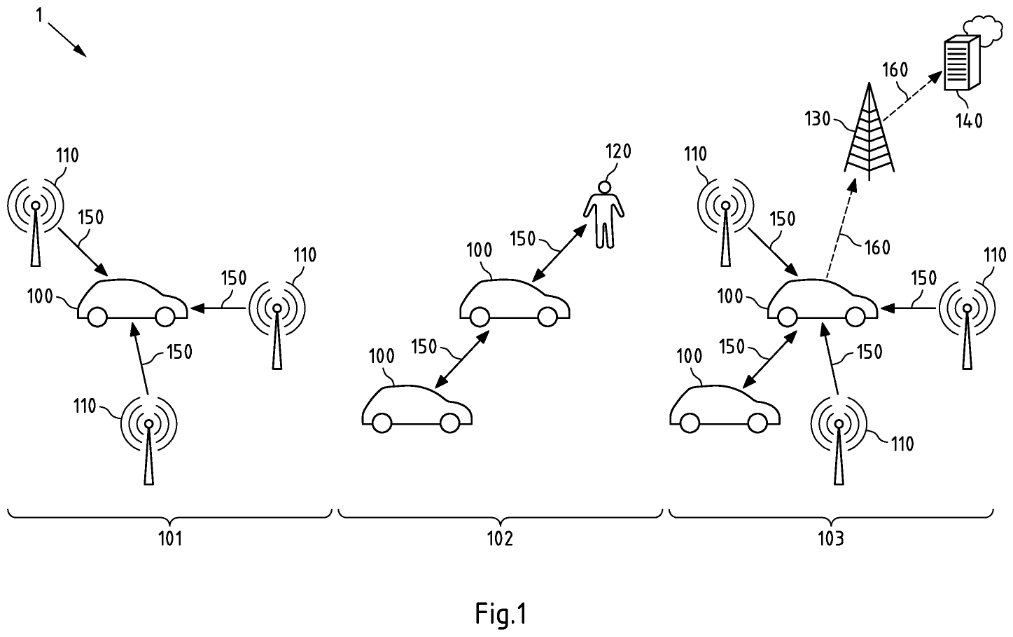

An example overview 1 of different SL positioning scenarios for vehicle-to-anything (V2X) and public safety applications is shown in FIG. 1. The overview depicts various vehicles 100 that may have on-board units, various road side units 110, a user device of a vulnerable road user 120 (e.g. a non-motorised road user, e.g. a cyclist or pedestrian), a gNB 130, a location server 140, the exchange of SL-PRSs 150 and measurement paths 160. Three example scenarios 101, 102, and 103 are shown in the overview. Scenario 101 illustrates a “sidelink absolute” scenario in which the absolute location, e.g., in terms of latitude and longitude, of the vehicle 100 as a target UE may be determined based on the known locations of other devices. Scenario 102 illustrates a “sidelink relative” scenario in which the central vehicle 100 as a target UE may determine its location relative to the location of other UEs, e.g. the other vehicle 100 and the vulnerable road user 120. Finally, scenario 103 illustrates a “sidelink assisted” scenario where the position of a vehicle 100 that acts as a target UE may be calculated by location services (LCS).

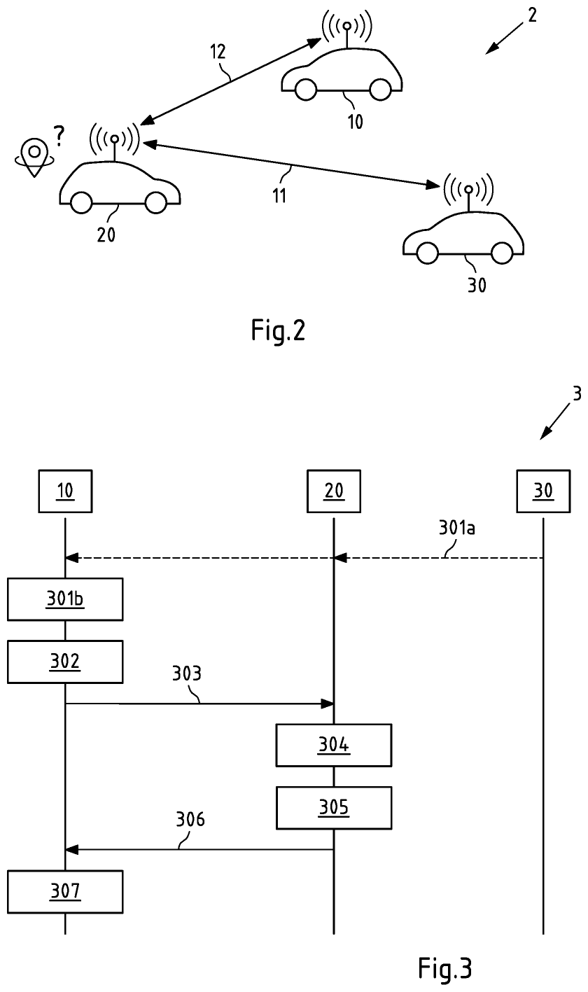

FIG. 2 shows a schematic diagram of a system 2 according to an example embodiment. By way of example, it illustrates a SL positioning scenario where a target UE 20 is performing an SL positioning session, e.g., exchanging SL-PRS 11, 12 with two anchor UEs 30, 10, respectively, in order to determine its location (e.g. by triangulation, for example additionally using a third anchor UE (not shown), to name but one non-limiting example). Here, the anchor UEs 10, 30 are said to provide SL-PRS assistance (incl. SL-PRS) to the target UE 20. By way of example, the target UE 20 and the anchor UEs 10, 30 are vehicles or comprised in vehicles. However, one or more of the target UE 20 or the anchor UEs 10, 30 may be embodied differently as any other apparatus. Furthermore, in various embodiments, there may be more target UEs and/or there may be more or less anchor UEs.

The UEs 10, 20, 30 may perform autonomous resource selection, e.g., using the mode 2 explained before. Specifically, anchor UEs 10, 30 may perform autonomous resource selection (distributed resource allocation) and/or there may be no central entity to allocate resources for SL-PRSs to anchor UE 10 and/or 30.

Optionally, the anchor UE 10 may receive a first SL-PRS resource reservation information indicating reservation of one or more first resources for transmission of the one or more first SL-PRSs 11. The first SL-PRS resource reservation information may have been transmitted by the anchor UE 30.

The anchor UE 10 may determine whether to reuse at least a part of the first SL-PRS resource for its own second SL-PRS transmission 12 or not. Sharing of resources between SL-PRS transmissions is different from conventional SL scheduling procedures for data/control transmission that avoid the reuse of the same time/frequency resources by the nearby UEs.

The anchor UE 10 may determine whether to reuse at least a part of the first SL-PRS resource for its own second SL-PRS transmission 12 or not, for example upon monitoring the first SL-PRS resource reservation for a first SL-PRS transmission 12. The determining may be based on a reaction, e.g., a feedback, e.g. on PSFCH, from the target UE 20 (or multiple target UEs) that is/are the intended recipient(s) of the first SL-PRS transmission 11 and/or the second SL-PRS transmission 12. To that end, the anchor UE 10 may send a request to the target UE 20 to use at least part of the resources allocated to the first SL-PRS 11. The target UE 20 may provide a reaction, e.g., a response to accept or reject the request from the anchor UE 10 to use the resources allocated to the first SL-PRS 11 for a second SL-PRS transmission 12 (e.g. in parallel). Thus, in various embodiment, if the request is accepted, the second SL-PRS transmission 12 may happen at least partly simultaneously with the first SL-PRS transmission 11. The anchor UE 10 may reuse the time-frequency resources used by the anchor UE 30 for transmission of the first SL-PRS 11. However, the anchor UE 10 may use a code (e.g., a second code) in code-domain that is different from a code (e.g., a first code) used for the transmission of the one or more first SL-PRSs 11. This may enable the target UE 20 to distinguish the first and the second SL-PRSs. But, in scenarios where the transmitter of the first SL-PRS (UE 30) is identified and/or estimated to be, e.g. significantly, far from UE 10, UE 10 may determine to use the same code as the UE 30. Thus, in such example scenarios, the second code may be the same as the first code. Particularly in this case, UE 10 may be considered to, e.g. explicitly, indicate the usage of the second code in the request message.

As described above, in various embodiments, the anchor UE 10 may send a request to the target UE 20 to (re) use at least part of the one or more first resources allocated to the transmission of the one or more first SL-PRSs 11, and the target UE 20 may provide a reaction, e.g. provide a response to accept or reject the request from the anchor UE 10 to use the resources allocated to the first SL-PRS 11 for a second SL-PRS transmission 12. This is different from conventional SL feedback procedures as an intended recipient provides a reaction, e.g., sends a feedback indication to another UE (the anchor UE 10) relating to future SL-PRS transmission aggregation, e.g., reusing the resources, instead of sending feedback to a transmitter UE relating to a previously transmitted message.

Using one of the various embodiments may increase the sidelink resource utilization and/or reduce channel congestion while meeting the accuracy (in terms of distinguishability/SINR) and/or latency requirements of SL positioning.

FIG. 3 describes transmissions and actions 3 performed by apparatuses according to example embodiments of all example aspects. Specifically, FIG. 3 shows transmissions and actions of a first apparatus (i.e., a first device) according to an example embodiment. By way of example, the first apparatus is embodied as a first anchor UE UE-X 10. A second apparatus (i.e., a second device) performing transmissions and actions according to an example embodiment is, by way of example, embodied as a target UE UE-T1 20. A third apparatus (i.e., a third device) is, by way of example, embodied as a second anchor UE UE-A1 30.

Step 301a relates to an optional SL-PRS resource reservation. For example, UE-A1 30 may transmit a first SL-PRS resource reservation information indicating reservation of one or more first resources for transmission of one or more first SL-PRSs. Thus, the anchor UE, UE-A1 30, may indicate, via e.g. SCI, a reservation of a time-frequency-code SL-PRS resource for its future SL-PRS transmission. This may be done via broad- or groupcasting, to name but a few non-limiting examples so that e.g. UE-X 10 and UE-T1 20 are enabled to receive it.

Optionally, in Step 301b, UE-X 10 may receive the first SL-PRS resource reservation information indicating reservation of the one or more first resources for transmission of the one or more first SL-PRSs. Specifically, UE-X 10 may receive the resource indication message from anchor UE-A1 30 and identify the SL-PRS resource in which anchor UE-A1 will transmit its SL-PRS. To increase the resource utilization, anchor UE-X 10 may attempt to aggregate/place its own SL-PRS transmission at the same time-frequency resource in which the anchor UE-A1 30 intends to transmit its SL-PRS.

In step 302, UE-X 10 may determine a resource that may be used for transmitting a request message requesting to use at least part of one or more first resources that are designated for transmission of one or more first SL-PRSs for transmitting a second SL-PRS. Thus, by way of example, before accessing/using a SL-PRS resource for transmitting a second SL-PRS, e.g. SL-PRS resource reserved by the anchor UE-A1 30 or a dedicated SL-PRS resource (where the SL-PRS transmissions are restricted to be performed in only those dedicated SL-PRS resources, e.g. certain periodic time slots), anchor UE-X 10 may determine a resource in which it can send a request to use the SL-PRS resource.

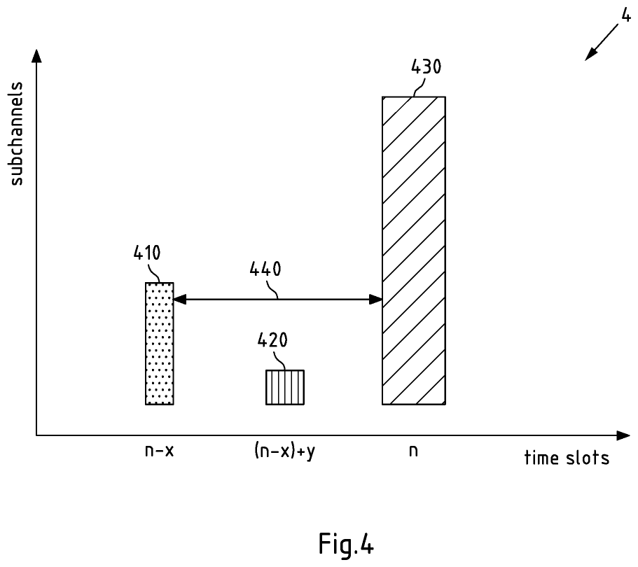

In various embodiments of all example aspects, the request message may be transmitted using a resource that has a pre-configured position relative to the one or more first resources. This will be described with respect to FIG. 4.

FIG. 4 shows an illustration 4 of using a resource that has a pre-configured position relative to the one or more first resources for a request message according to an example embodiment. Specifically, FIG. 4 shows a first SL-PRS resource 430 designated for transmission of one or more first SL-PRSs. The first SL-PRS resource 430 may have been reserved by UE-A1 30 for transmission of the one or more first SL-PRSs.

There may be a pre-configured position relative to the first SL-PRS resource 430 in which the request message may be transmitted. Specifically, a time and/or frequency resource offset (in terms of e.g. time slots and/or subchannels) may be configured, e.g. time offset 440 corresponding, by way of example, to x slots, such that there may exist an implicit mapping from the request message transmission resource 410 to the SL-PRS resource 430 associated with the request, as shown in FIG. 4. Given an example time offset x, to access the SL-PRS resource at (n)th slot (which may already be reserved by UE-A1 30, as optionally monitored in step 301b, e.g. by decoding SCI sent from UE-A), the request message is sent in (n−x)th slot 410. A reaction to the request message may be provided and observed, e.g., in resource 420.

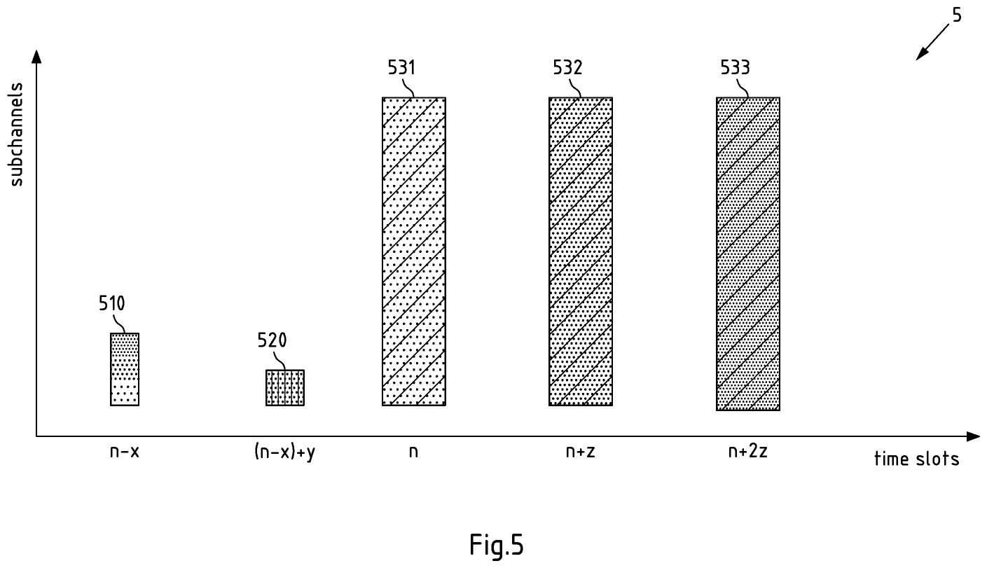

Another example way to transmit the request message is using a resource that is pre-configured. Specifically, a resource may be pre-configured to be associated with one or more specific (e.g. first) resources to be used for transmitting a second SL-PRS. This will be described with reference to FIG. 5.

FIG. 5 shows an illustration 5 of using a pre-configured resource for a request message according to an example embodiment. Specifically, FIG. 5 shows three first SL-PRS resources 531, 532, 533 designated for transmission of one or more first SL-PRSs. The first SL-PRS resources 531, 532, 533 may have been reserved by UE-A1 30 for transmission of first SL-PRSs.

A time-frequency resource 510 for transmitting a request message may be configured in association with occurrence of the one or more SL-PRS resources 531, 532, 533 as shown in FIG. 5. By performing a transmission in the request message resource 510, a request may be conveyed to use the associated SL-PRS(s) resources 531, 532, 533, e.g., in a Semi persistent scheduling (SPS) manner. When there are multiple SL-PRS resources 531, 532, 533 configured, different reactions, e.g. sequences or response messages, may be used by the target UE-T1 20 to (e.g. explicitly) allow and/or deny the usage of one or more specific SL-PRS resources 531, 532, 533, e.g., in an interval.

In various embodiments of all example aspects, UE-T1 (e.g. UE-T1 20 of FIG. 3) can direct the reaction to the specific UE-X 10 using Layer 1 ID of UE-X 10 (e.g., when there are multiple anchor UEs).

It is noted, unlike the case shown in FIG. 4 in which the request message may be sent using a time-frequency resource 410 before or prior to the usage of the intended SL-PRS resource 430 (e.g. implicit mapping between the request message resource 410 and the SL-PRS resource 430), FIG. 5 deals with a case where certain resources may be explicitly configured, e.g. by the network, for requesting the usage of certain specific SL-PRS resources 531, 532, 533 (explicit mapping case). By way of example, in FIG. 5, SL-PRS resources 531, 532, 533 that may be SPS like and/or periodic are considered, and at a given interval a number, e.g. three, SL-PRS resources 531, 532, 533 are configured with equidistant time offsets, e.g., time offset of z slots. To access any of the SL-PRS resources 531, 532, 533 within a given interval, e.g., SL-PRS resources 531 at (n)th slot, 532 at (n+z)th slot or 533 at (n+2z)th slot, UE-X 10 may send a request message (e.g. a part of the SL-PRS sequence, e.g., of the second SL-PRS) in the explicitly configured resource 510 for request message transmission.

By way of example, UE-A1 30 (e.g. of FIG. 3) is considered to be already using any of the three SL-PRS resources 531, 532, 533 available in the given interval (since it is using a SL-PRS resource in an SPS manner). Upon receiving the request message from UE-X 10 (e.g. of FIG. 3), the target UE-T1 20 (e.g. of FIG. 3) may provide a response, e.g. in the configured PSFCH resource, to allow (or deny) UE-X 10 to use any one of the SL-PRS resources 531, 532, 533 in the given interval (cf. steps 305 and 306). As an example related to FIG. 5, UE-T1 20 may allow UE-X 10 to use (e.g. only) the SL-PRS resource 532 available at (n+z)th slot (2nd SL-PRS resource within the interval) in an SPS manner, e.g., by sending an associated sequence as response (e.g., in the resource 520 shown in FIG. 5). This embodiment may enable progressive filling of SL-PRS resources so that, for example, UE-T1 20 can allow multiple SL-PRS transmissions from anchor UEs in the (n)th slot 531, e.g., up to a predetermined number, before allowing the usage of (n+z)th slot 532.

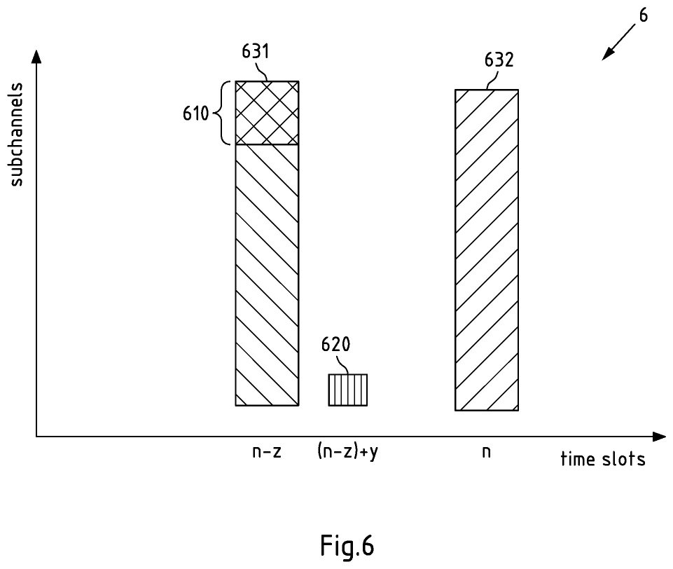

Another example way to transmit the request message is using a resource that is designated for transmission of one or more SL-PRSs. This will be described with reference to FIG. 6.

FIG. 6 shows an illustration 6 of using a resource that is designated for transmission of one or more SL-PRSs for a request message according to an example embodiment. Specifically, FIG. 6 shows a first SL-PRS resource 632 designated for transmission of one or more first SL-PRSs and another, e.g. first SL-PRS resource 631 designated for transmission of one or more SL-PRS. One or more of SL-PRS resources 631, 632 may have been reserved by UE-A1 30 for transmission of one or more first SL-PRSs. In various embodiments, UE-X 10 (e.g. of FIG. 3) may use a part 610 of SL-PRS resource 631 to transmit the request for usage of another SL-PRS 631, as shown in FIG. 6. A reaction to the request message may be provided and observed, e.g., in resource 620.

Furthermore, in various embodiments, the request message may be transmitted using sidelink control information which indicate the at least part of the one or more first resources that are designated for transmission of one or more first SL-PRSs for which use for transmitting the second SL-PRS is requested.

In the following, the description of FIG. 3 will be continued.

In step 303, UE-X 10 may transmit the request message requesting to use (or reuse) at least part of one or more first resources that are designated for transmission of one or more first SL-PRSs for transmitting a second SL-PRS. For doing so UE-X 10 may use the one or more resources determined in step 302. The target UE (UE-T1) 20 of anchor UE-A1 30 and/or anchor UE-X 10 may monitor the resources in which the request message is expected. Thus, it may receive the request message requesting to use at least part of one or more first resources that are designated for transmission of one or more first SL-PRSs for transmitting a second SL-PRS.

The request message may indicate control information associated with the second SL-PRS. Specifically, the request may contain the SL-PRS configuration (e.g., SL-PRS sequence identifier) of UE-X 10.

In step 304, UE-T1 20 may determine whether use of the at least part of the one or more first resources is acceptable for transmitting the second SL-PRS. This may be done based on one or more predetermined parameters. For example, target UE-T1 20 may determine whether the request to use the at least part of the SL-PRS resources is acceptable or not, based on the expected SL-PRS reception performance (in terms of, e.g., SINR and/or ability to decode) from the respective anchor UEs, e.g., UE-X 10 and/or UE-A1 30, given that anchor UE-X 10 uses the same SL-PRS resource with the indicated SL-PRS configuration, e.g., the indicated configuration for the second SL-PRS. Parameters may be or comprise a rate of past successful transmissions from UE-X 10 and/or from UE-A1 30, an indicator for a link quality between UE-X 10 and UE-T1 20 and/or between UE-A1 30 and UE-T1 20, and/or information indicating a proximity between UE-X 10 and UE-T1 20 and/or UE-A1 30 and UE-T1 20, and/or control information indicated by UE-X 10 and/or UE-A1 30.

It is noted that, under various circumstances, target UE-T1 20 may foresee the SL-PRS reception performance with ease when the resources for transmission of the request message are configured as described with respect to FIG. 4, 5 or 6. The reason is that UE-T1 20 may be able to directly observe the SINR performance in the request message and it may determine whether the SINR performance is above a certain threshold, for instance even when the UE-X 10 accesses the (e.g. first) resource.

Optionally, in step 305, UE-T1 20 may determine one or more physical sidelink feedback channel resources that are used for a reaction to the request message.

In step 306, UE-T1 20 may perform a reaction to the request message, e.g., based on the outcome of the determining whether use of the at least part of the one or more first resources is acceptable for transmitting the second SL-PRS or not. The reaction to the request message may indicate whether use of at least part of the one or more first resources that are designated for the transmission of one or more first SL-PRSs for transmitting the second SL-PRS is accepted or not. UE-X 10 may observe the reaction to the request message. By way of example, the reaction may indicate that the requesting is denied if it corresponds to a denial response being transmitted. By way of example, it may indicate that the requesting is partly denied if it corresponds to a response being transmitted indicating a part of the one or more first resources for which use is denied. Finally, by way of example, it may indicate that the requesting is accepted if it corresponds to no response to the request message being transmitted in one or more resources that are used for the reaction to the request.

Specifically, when UE-T1 20 determined that the usage of the SL-PRS resource by anchor UE-X 10 is unacceptable, target UE-T1 20 may determine a PSFCH resource to transmit the reject indication.

As can be seen in FIGS. 4-6, a respective PSFCH resource 420, 520, 620 may be configured, e.g., with a time offset of y from the request indication resource 410, 510, 610 for response from target UE-T1 20. For example, a respective PSFCH resource deriving rule similar to that of TS 38.213 can be used to determine/calculate the index of the PSFCH resource 420, 520, 620. For instance, target UE-T1 20 and/or anchor UE-X 10 may determine an index of a PSFCH resource 420, 520, 620 for a reaction, e.g., a PSFCH (response) transmission, in response to the request reception in step 303. The index may be determined as (P_{ID}+M_{ID})modR_{PRB,CS}^{PSFCH}. P_{ID} may be a physical layer/L1 source ID provided, e.g., by SCI, e.g., in step 303. M_{ID} can be set e.g. as 0. R_{PRB,CS}^{PSFCH} may be the number of PSFCH resources available for multiplexing, e.g., HARQ-ACK information in a PSFCH transmission.

For NACK-only like configuration, target UE-T1 20 may be configured to send NACK in case of ‘reject’ response from target UE-T1 20. Additionally or alternatively, target UE-T1 20 may be configured to use either or both ACK and NACK sequences to indicate one or more SL-PRS resources in which the transmission of the second SL-PRS by anchor UE-X 10 is acceptable or unacceptable. For example, in FIG. 5, when anchor UE-X 10 indicates its request (in slot (n−x) 510) to use the SL-PRS resources 531, 532, 533 in slot n, n+z and n+2z, the target UE-T1 20 may use different ACK/NACK sequences to indicate its preference. That is, e.g. a NACK, ACK and NACK+ACK signal may be used to indicate rejection to use SL-PRS resource at slot n, n+z and n+2z, respectively. “No explicit feedback in terms of a transmitted message” may be understood as ‘accept’ response from target UE-T1 20.

So in various embodiments of all example aspects, step 306 may not involve actively transmitting a message in response to each request message. Instead, not transmitting a message, e.g. in the determined one or more PSFCH resources, may be a reaction sufficient to indicate a response according to a preconfigured protocol, e.g. an “accept” (or “reject”) response. Thus, based on the outcome of the determining whether use of the at least part of the one or more first resources is acceptable for transmitting the second SL-PRS and the used convention for indicating a response, UE-T1 20 may use the PSFCH resource and possibly one or more determined response sequences to provide its reaction.

In various embodiments of all example aspects, in step 306, the target UE-T1 20 may transmit a response message indicating the outcome of the determining whether use of the at least part of the one or more first resources is acceptable for transmitting the second SL-PRS or not. In this case, the response message may be transmitted via PSCCH and/or PSSCH and step 305 might be skipped.

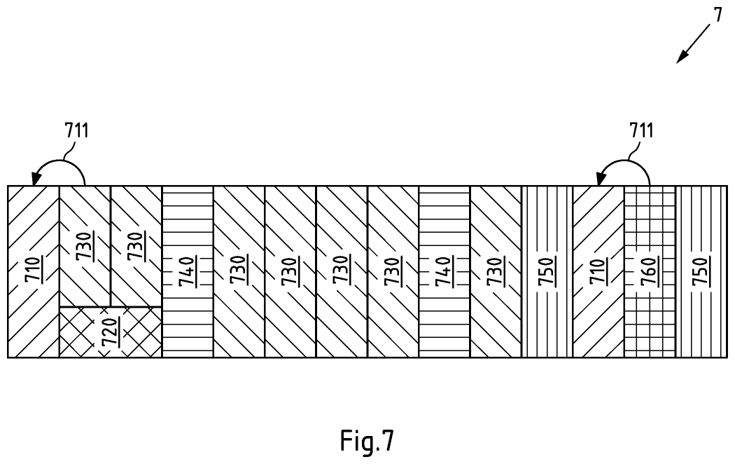

FIG. 7 shows an example 7 of a PSCCH/PSSCH slot in which a PSFCH is sent in one symbol among the last SL symbols. In the particular example shown in FIG. 7, the PSFCH may be sent in the penultimate SL symbol. A, e.g. second, e.g. OFDM, symbol of PSFCH transmission in a slot may be defined as l′=sl-StartSymbol+sl-LengthSymbols−2. However, these are merely examples and PSFCH may be transmitted in any symbol of a slot. A UE may be provided, e.g. by a network node, with information that may enable the UE to derive or determine a symbol in a slot in which PSFCH can be expected or transmitted.

The slot shown in FIG. 7 contains or comprises, by way of example, 14 sidelink symbols. Specifically, the slot comprises 1 PSFCH symbol 760, 2 PSCCH symbols 720, 7 PSSCH symbols 730, and 2 PSCCH Demodulation Reference Signal (DMRS) symbols 740. Additionally, the slot contains or comprises 2 guard periods 750 and two Automatic Gain Control (AGC) symbols 710. The AGC symbols 710 are duplicates of the respective subsequent symbols, as indicated by the arrows 711.

PSFCH may be used in various embodiments and, additionally, in traditional HARQ procedure.

In traditional HARQ procedure, the Rx UEs may use HARQ feedback (ACK/NACK) to convey to the Tx UE whether or not the SL transmission from the Tx UE is successfully received by the Rx UE. In contrast, in various embodiments, the target UEs, e.g., UE-T1 20 may use HARQ-like FB (i.e. HARQ-like sequences) to the anchor UE(s), e.g., UE-X 10 to grant/not grant SL-PRS resource usage by the anchor UE(s), e.g., UE-X 10.

A PSFCH resource configured for the HARQ procedure may be different from a PSFCH resource configured for various embodiments. That means it may be a different resource as the embodiments may be configured on a different PSFCH resource pool so that it does not overlap with the PSFCH resources meant for traditional SL HARQ FB. Thus, it is possible to not alter the traditional HARQ procedure. Instead, a new ‘HARQ-like’ procedure for SL positioning resource allocation is proposed which may run independently from the traditional HARQ procedure.

‘HARQ-like’ procedure may mean that sequences similar to those sequences used in traditional HARQ procedure (e.g., ACK/NACK-like sequences) may be used for conveying from the target UE-T1 20 to the anchor UE-X 10 whether or not the target UE-T1 20 accepts the SL-PRS resource usage request sent by the anchor UE-X 10. Again, this may run independently from the traditional HARQ procedure that is designed for providing feedback on whether or not the SL transmission is successfully received.

Now the final step shown in FIG. 3 will be described.

In step 307, UE-X 10 may determine, based on the observed reaction, whether use of the at least part of the one or more first resources is accepted for transmitting the second SL-PRS. If it has been determined that the use is accepted, it may transmit the second SL-PRS using the at least part of the one or more first resources. It may transmit the second SL-PRS using a second code in a code-domain whereas the one or more first SL-PRSs may be transmitted using a first code in the code-domain. The second code may be different from, e.g. orthogonal to, or the same as the first code used for the transmission of the one or more first SL-PRSs. If it has been determined that the use is rejected, it may refrain from transmitting the second SL-PRS using the at least part of the one or more first resources.

Thus, anchor UE-X 10 may, based on the feedback received in step 306, determine whether or not to use the indicated (e.g., in step 303) SL-PRS resource. For example, UE-T1 20 may indicate ‘reject’ by means of transmitting feedback so that UE-X 10 does not use the indicated SL-PRS resource. Otherwise, anchor UE-X 10 may use the SL-PRS resource. This may contribute to increasing channel utilization while ensuring that the accuracy requirements are met at the target UEs.

As described, FIG. 3 illustrates transmissions and actions performed by two anchor UEs UE-X 10 and UE-A1 30 and one target UE-T1 20. However, various embodiments may be used in the context of more apparatuses. For example, there may be multiple target UEs.

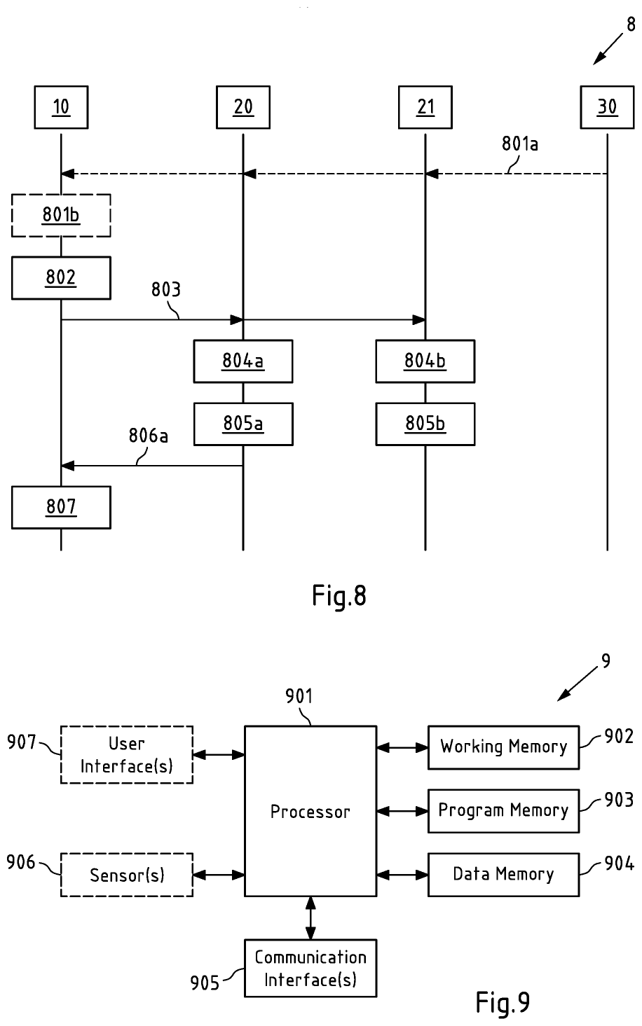

FIG. 8 shows transmissions and actions 8 performed by apparatuses according to example embodiments, wherein by way of example two apparatuses perform an embodiment of the method according to the second aspect.

As compared to FIG. 3, FIG. 8 relates to one or more additional target UE-T2 21 (only one UE-T2 is depicted). However, the actions and transmission performed by single UEs in FIG. 8 are similar to or the same as the corresponding actions and transmissions discussed with respect to FIG. 3.

Specifically, steps 801a, 801b, and 802 correspond to steps 301a, 301b, and 302 described with respect to FIG. 3, respectively.

Furthermore, from the perspective of UE-X 10, step 803 may correspond to step 303, i.e., UE-X 10 may transmit the request message. The transmission may be a broadcast transmission. Thus, it may be received both by UE-T1 20 and UE-T2 21. Whether or not one or more target UEs receive the request message may depend, e.g., on their respective distance to UE-X 10 and the transmission power.

Each of UE-T1 20 and UE-T2 21 may carry out the actions described with respect to steps 304, 305, and 306, e.g., UE-T1 20 may do so in steps 804a, 805a, and 806a and UE-T2 21 may do so in steps 804b, 805b.

By way of example, it is illustrated that only target UE-T1 20 which considers the indicated SL-PRS resource usage by the anchor UE-X 10 to be unacceptable responds with a NACK sequence in the PSFCH resource in step 806a. UE-T2 21 may not transmit a message to UE-X 10, e.g. because it accepts the request. To illustrate this difference, no step 806b arrow is shown. However, this is not to be understood to mean that an arrow like arrow 306 in FIG. 3 means that a message must be transmitted.

Anchor UE-X 10 may upon receiving the NACK sequence from at least one target UE (UE-T1 in the example) inhibit from using the indicated SL-PRS resource. In contrast, if both UE-T1 20 and UE-T2 21 had accepted the request, UE-X 10 might have use the indicated SL-PRS resource. The determining which action to take may be done in step 807 which is similar to step 307 described before.

Overall, various embodiments of all example aspects may increase the sidelink resource utilization and/or reduce channel congestion, while targeting to meet the accuracy (e.g., in terms of distinguishability/SINR) and/or latency requirements of SL positioning. Moreover, various embodiments of all example aspects may enable anchor UEs to send SL-PRS even when the channel is more occupied (e.g., under high CBR), by exploiting the possibility to aggregate multiple SL-PRS sequences in one time-frequency resource, yet achieving the accuracy requirements.

FIG. 9 is a schematic block diagram of an apparatus 9 according to the first or second example aspect. Apparatus 9 may for instance represent the first or second apparatus 10 or 20.

Apparatus 9 comprises a processor 901, a working memory 902, a program memory 903, a data memory 904, and communication interface(s) 905. In various embodiments, the apparatus 9 comprises further units, parts or structural and/or functional elements. In various embodiments, apparatus 9 is a user equipment, e.g., for a cellular network like 5G NR.

Apparatus 9 may for instance be configured to perform and/or control or comprise respective means (at least one of 901 to 907) for performing and/or controlling and/or configured to perform the method according to the first or second example aspect. Apparatus 9 may as well constitute an apparatus comprising at least one processor 901 and at least one memory 901 including computer program code, the at least one memory 901 and the computer program code configured to, with the at least one processor 901, cause an apparatus, e.g. apparatus 9 at least to perform and/or control the method according to the first or second example aspect.

Processor 901 may for instance further control the memories 902 to 904, and/or the communication interface(s) 905.

Processor 901 may for instance execute computer program code stored in program memory 903, which may for instance represent a computer readable storage medium comprising program code that, when executed by processor 901, causes the processor 901 to perform the method according to the first or second example aspect.

Processor 901 (and also any other processor mentioned in this specification) may be a processor of any suitable type. Processor 901 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 901 may for instance be an application processor that runs an operating system.

Program memory 903 may also be included into processor 901. This memory may for instance be fixedly connected to processor 901, or be at least partially removable from processor 901, for instance in the form of a memory card or stick. Program memory 903 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 903 may also comprise an operating system for processor 901. Program memory 903 may also comprise a firmware for apparatus 9.

Apparatus 9 may comprise a working memory 902, for instance in the form of a volatile memory. It may for instance be a Random Access Memory (RAM) or Dynamic RAM (DRAM), to give but a few non-limiting examples. It may for instance be used by processor 901 when executing an operating system and/or computer program.

Data memory 904 may for instance be a non-volatile memory. It may for instance be a FLASH memory (or a part thereof), any of a ROM, PROM, EPROM and EEPROM memory (or a part thereof) or a hard disc (or a part thereof), to name but a few examples.

Communication interface(s) 905 enable apparatus 9 to communicate with other entities, e.g. with one or more of the apparatuses 100, 110, 120, 130 of FIG. 1 and/or one or more of the apparatus 10, 20, 21, 30 of FIGS. 2, 3, and 8 and/or network nodes, e.g. of the same network. The communication interface(s) 905 may for instance comprise a wireless interface, e.g. a cellular radio communication interface and/or a WLAN interface) and/or wire-bound interface, e.g. an IP-based interface, for instance to communicate with entities via the Internet or a network backbone, e.g. a 5G NR backbone.

Sensor(s) 906 are optional and may for instance comprise a gyroscope, global positioning system sensor or a received signal strength sensor.

User interface 907 is optional and may comprise a display for displaying information to a user and/or an input device (e.g. a keyboard, keypad, touchpad, mouse, etc.) for receiving information from a user.

Some or all of the components of the apparatus 9 may for instance be connected via a bus. Some or all of the components of the apparatus 9 may for instance be combined into one or more modules.

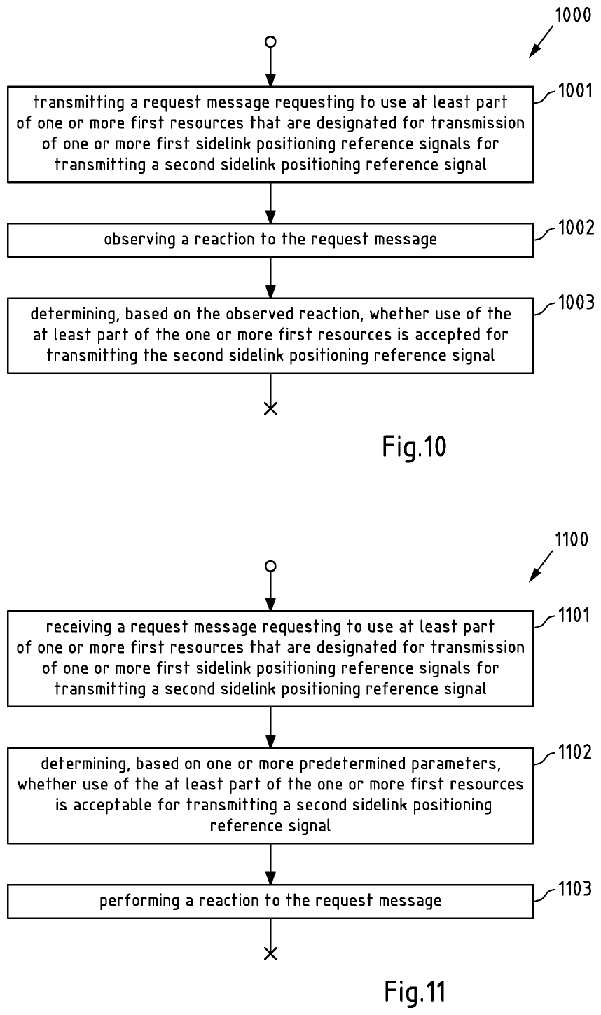

FIG. 10 shows a flowchart 1000 of an example embodiment of a method according to the first example aspect. One or more of the steps of flow chart 1000 may, e.g., be performed by a first apparatus, e.g. a UE, e.g. UE 10 of FIGS. 2, 3 and/or 8.

Step 1001 comprises transmitting a request message requesting to use at least part of one or more first resources that are designated for transmission of one or more first sidelink positioning reference signals for transmitting a second sidelink positioning reference signal. This may be done, for example, as described with reference to FIGS. 4-6 and/or using SCI, as described before.

Step 1002 comprises observing a reaction to the request message. This may comprise, for example, receiving a denial or acceptance response, e.g. using one or more PSFCH resources. Additionally or alternatively, it may comprise observing that one or more, e.g. PSFCH, resources remain unused for a response.

Step 1003 comprises determining, based on the observed reaction, whether use of the at least part of the one or more first resources is accepted for transmitting the second sidelink positioning reference signal. For example, when a denial response was received in step 1002, it may be determined to not use the at least part of the one or more first resources for transmitting the second SL-PRS. On the other hand, when an acceptance response or, e.g. no response, was received, it may be determined to use the at least part of the one or more first resources for transmitting the second SL-PRS. Based on the determining, the second SL-PRS may be transmitted or not.

FIG. 11 shows a flowchart 1100 of an example embodiment of a method according to the second example aspect. One or more of the steps of flow chart 1000 may, e.g., be performed by a second apparatus, e.g. a UE, e.g. UE 20 or 21 of FIGS. 2, 3 and/or 8.

Step 1101 comprises receiving a request message requesting to use at least part of one or more first resources that are designated for transmission of one or more first sidelink positioning reference signals for transmitting a second sidelink positioning reference signal. This step may correspond to step 1001 of FIG. 10. It may be done, for example, as described with reference to FIGS. 4-6 and/or using SCI, as described before.

Step 1102 comprises determining, based on one or more predetermined parameters, whether use of the at least part of the one or more first resources is acceptable for transmitting a second sidelink positioning reference signal. The one or more predetermined parameters may relate to an estimated reception quality of the one or more first SL-PRS and/or the second SL-PRS in the one or more first resources.

Step 1103 comprises performing a reaction to the request message. This may be done based on the determining. It may correspond to step 1003 of FIG. 10. It may comprise, e.g., transmitting a response message indicating the outcome of the determining whether use of the at least part of the one or more first resources is acceptable for transmitting the second SL-PRS or not. The response message may be transmitted, e.g., using one or more PSFCH resources. Additionally or alternatively, the reaction may comprise not using one or more, e.g. PSFCH, resources.

The expression “A and/or B” and the expression “at least one of A or B” are respectively considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only examples, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program) may also be used in a corresponding manner in an example embodiment of any other category. It should also be understood that presence of a feature in the presented example embodiments shall not necessarily mean that this feature forms an essential feature which cannot be omitted or substituted.

The sequence of method steps presented above, e.g. in the flowcharts, is not mandatory, also alternative sequences may be possible. Nevertheless, the specific sequence of method steps exemplarily shown in the figures shall be considered as one possible sequence of method steps for the respective embodiment described by the respective figure. Further, in various embodiments, a step of a sequence may trigger another step of the sequence, for instance the following step in the sequence.

Finally, the following embodiments should also be considered to be disclosed:

### Embodiment 1

A method comprising:
transmitting a request message requesting to use at least part of one or more first resources that are designated for transmission of one or more first sidelink positioning reference signals for transmitting a second sidelink positioning reference signal; and
observing a reaction to the request message; and
determining, based on the observed reaction, whether use of the at least part of the one or more first resources is accepted for transmitting the second sidelink positioning reference signal.

### Embodiment 2

The method according to embodiment 1, further comprising:
if it has been determined that the use is accepted, transmitting the second sidelink positioning reference signal using the at least part of the one or more first resources.

### Embodiment 3

The method according to embodiment 2, wherein the one or more first sidelink positioning reference signals are transmitted using a first code in a code-domain and the second sidelink positioning reference signal is transmitted using a second code in the code-domain.

### Embodiment 4

The method according to embodiment 3, wherein the first code and the second code are the same.

### Embodiment 5

The method according to any of embodiments 1 to 4, further comprising:
receiving a first sidelink positioning reference signal resource reservation information indicating reservation of the one or more first resources for transmission of the one or more first sidelink positioning reference signals, wherein the request is transmitted after receiving the first sidelink positioning reference signal resource reservation information.

### Embodiment 6

The method according to any of embodiments 1 to 5, wherein the reaction to the request message indicates whether use of at least part of the one or more first resources that are designated for the transmission of one or more first sidelink positioning reference signals for transmitting the second sidelink positioning reference signal is accepted.

### Embodiment 7

The method according to any of embodiments 1 to 6, further comprising:
determining one or more physical sidelink feedback channel resources that are used for the reaction to the request message.

### Embodiment 8

The method according to any of embodiments 1 to 7, wherein the reaction indicates that the requesting is denied if it corresponds to a denial response being transmitted and/or wherein the reaction indicates that the requesting is partly denied if it corresponds to a response being transmitted indicating a part of the one or more first resources for which use is denied and/or wherein the reaction indicates that the requesting is accepted if it corresponds to no response to the request message being transmitted in one or more resources that are used for the reaction to the request and/or wherein the reaction indicates that the requesting is accepted if it corresponds to an acceptance response being transmitted.

### Embodiment 9

The method according to any of embodiments 1 to 8, wherein the request message indicates control information associated with the second sidelink positioning reference signal.

### Embodiment 10

The method according to embodiment 9, wherein the control information indicates information related to the second sidelink positioning reference signal.

### Embodiment 11

The method according to any of embodiments 1 to 10, wherein the request message is transmitted according to one or more of the following options:
(i) using a resource that has a pre-configured position relative to the one or more first resources; and/or
(ii) using a resource that is pre-configured; and/or
(iii) using a resource that is designated for transmission of one or more sidelink positioning reference signals; and/or
(iv) using sidelink control information which indicate the at least part of the one or more first resources that are designated for transmission of one or more first sidelink positioning reference signals for which use for transmitting the second sidelink positioning reference signal is requested.

### Embodiment 12

A method comprising:
receiving a request message requesting to use at least part of one or more first resources that are designated for transmission of one or more first sidelink positioning reference signals for transmitting a second sidelink positioning reference signal;
determining, based on one or more predetermined parameters, whether use of the at least part of the one or more first resources is acceptable for transmitting the second sidelink positioning reference signal; and
performing a reaction to the request message.

### Embodiment 13

The method according to embodiment 12, wherein the one or more predetermined parameters comprise one or more of:
(i) a rate of past successful transmissions from a first apparatus and/or from a third apparatus, the first apparatus requesting to use the at least part of the one or more first resources for transmitting the second sidelink positioning reference signal, the third apparatus transmitting the one or more first sidelink positioning reference signals; and/or
(ii) an indicator for a link quality between the first apparatus and a second apparatus and/or between the third apparatus and the second apparatus, the second apparatus performing the method; and/or
(iii) information indicating a proximity between the first apparatus and the second apparatus and/or the third apparatus and the second apparatus; and/or
(iv) control information indicated by the first apparatus and/or the third apparatus.

### Embodiment 14

The method according to any of embodiments 12 or 13, wherein a second apparatus receiving the request message receives a plurality of request messages respectively requesting to use at least part of the one or more first resources that are designated for transmission of the one or more first sidelink positioning reference signals for transmitting a respective second sidelink positioning reference signal, and wherein the reaction to the request message is configurable to indicate that a subset of the plurality of requests is denied and to indicate that another subset of the plurality of requests is accepted.

### Embodiment 15

The method according to any of embodiments 12 to 14, wherein the reaction to the request message indicates whether use of at least part of the one or more first resources that are designated for the transmission of one or more first sidelink positioning reference signals for transmitting the second sidelink positioning reference signal is accepted.

### Embodiment 16

The method according to any of embodiments 12 to 15, further comprising:
determining one or more physical sidelink feedback channel resources that are used for the reaction to the request message.

### Embodiment 17

The method according to any of embodiments 12 to 16, wherein the reaction indicates that the requesting is denied if it corresponds to a denial response being transmitted and/or wherein the reaction indicates that the requesting is partly denied if it corresponds to a response being transmitted indicating a part of the one or more first resources for which use is denied and/or wherein the reaction indicates that the requesting is accepted if it corresponds to no response to the request message being transmitted in one or more resources that are used for the reaction to the request and/or wherein the reaction indicates that the requesting is accepted if it corresponds to an acceptance response being transmitted.

### Embodiment 18

The method according to any of embodiments 12 to 17, wherein the request message indicates control information associated with the second sidelink positioning reference signal.

### Embodiment 19

The method according to embodiment 18, wherein the control information indicates information related to the second sidelink positioning reference signal.

### Embodiment 20

The method according to any of embodiments 12 to 19, wherein the request message is transmitted according to one or more of the following options:
(i) using a resource that has a pre-configured position relative to the one or more first resources; and/or
(ii) using a resource that is pre-configured; and/or
(iii) using a resource that is designated for transmission of one or more sidelink positioning reference signals; and/or
(iv) using sidelink control information which indicate the at least part of the one or more first resources that are designated for transmission of one or more first sidelink positioning reference signals for which use for transmitting the second sidelink positioning reference signal is requested.

### Embodiment 21

A first apparatus comprising respective means for performing the method of any of embodiments 1 to 11.

### Embodiment 22

A first apparatus comprising at least one processor and at least one memory including computer program code, the at least one memory and the computer program code configured to, with the at least one processor, cause an apparatus at least to perform and/or control the method according any of embodiments 1 to 11.

### Embodiment 23

A second apparatus comprising respective means for performing the method of any of embodiments 12 to 20.

### Embodiment 24

A second apparatus comprising at least one processor and at least one memory including computer program code, the at least one memory and the computer program code configured to, with the at least one processor, cause an apparatus at least to perform and/or control the method according any of embodiments 12 to 20.

### Embodiment 25

A computer program, the computer program when executed by a processor causing an apparatus, e.g. the apparatus according to any of embodiments 21 to 24, to perform and/or control the actions and/or steps of the method of any of embodiments 1 to 20.

### Embodiment 26

A computer program product comprising a computer program according to embodiment 25.

### Embodiment 27

A system comprising at least a first apparatus according to any of embodiments 21 or 22 and a second apparatus according to any of embodiments 23 or 24.

1.-18. (canceled)

19. A first apparatus comprising:
at least one processor; and
at least one memory including instructions, the at least one memory and the instruction configured to, with the at least one processor, cause the first apparatus at least to perform:
transmitting a request message requesting to use at least part of one or more first resources that are designated for transmission of one or more first sidelink positioning reference signals for transmitting a second sidelink positioning reference signal; and
observing a reaction to the request message; and
determining, based on the observed reaction, whether use of the at least part of the one or more first resources is accepted for transmitting the second sidelink positioning reference signal.

20. The first apparatus according to claim 19, wherein the first apparatus further configured to perform:
if it has been determined that the use is accepted, transmitting the second sidelink positioning reference signal using the at least part of the one or more first resources.

21. The first apparatus according to claim 20, wherein the one or more first sidelink positioning reference signals are transmitted using a first code in a code-domain and the second sidelink positioning reference signal is transmitted using a second code in the code-domain.

22. The first apparatus according to claim 21, wherein the first code and the second code are the same.

23. The first apparatus according to claim 19, wherein the first apparatus further configured to perform:
receiving a first sidelink positioning reference signal resource reservation information indicating reservation of the one or more first resources for transmission of the one or more first sidelink positioning reference signals, wherein the request is transmitted after receiving the first sidelink positioning reference signal resource reservation information.

24. The first apparatus according to claim 19, wherein the reaction to the request message indicates whether use of at least part of the one or more first resources that are designated for the transmission of one or more first sidelink positioning reference signals for transmitting the second sidelink positioning reference signal is accepted.

25. The first apparatus according to claim 19, further comprising means for:
determining one or more physical sidelink feedback channel resources that are used for the reaction to the request message.

26. The first apparatus according to claim 19, wherein the reaction indicates that the requesting is denied if it corresponds to a denial response being transmitted and/or wherein the reaction indicates that the requesting is partly denied if it corresponds to a response being transmitted indicating a part of the one or more first resources for which use is denied and/or wherein the reaction indicates that the requesting is accepted if it corresponds to no response to the request message being transmitted in one or more resources that are used for the reaction to the request and/or wherein the reaction indicates that the requesting is accepted if it corresponds to an acceptance response being transmitted.

27. The first apparatus according to claim 19, wherein the request message indicates control information associated with the second sidelink positioning reference signal.

28. The first apparatus according to claim 27, wherein the control information indicates information related to the second sidelink positioning reference signal.

29. The first apparatus according to claim 19, wherein the request message is transmitted according to one or more of the following options:
(i) using a resource that has a pre-configured position relative to the one or more first resources; and/or
(ii) using a resource that is pre-configured; and/or
(iii) using a resource that is designated for transmission of one or more sidelink positioning reference signals; and/or
(iv) using sidelink control information which indicate the at least part of the one or more first resources that are designated for transmission of one or more first sidelink positioning reference signals for which use for transmitting the second sidelink positioning reference signal is requested.

30. A method comprising:
transmitting a request message requesting to use at least part of one or more first resources that are designated for transmission of one or more first sidelink positioning reference signals for transmitting a second sidelink positioning reference signal; and
observing a reaction to the request message; and
determining, based on the observed reaction, whether use of the at least part of the one or more first resources is accepted for transmitting the second sidelink positioning reference signal.

31. The method according to claim 30, further comprising:
if it has been determined that the use is accepted, transmitting the second sidelink positioning reference signal using the at least part of the one or more first resources.

32. The method according to claim 31, wherein the one or more first sidelink positioning reference signals are transmitted using a first code in a code-domain and the second sidelink positioning reference signal is transmitted using a second code in the code-domain.

33. The method according to claim 32, wherein the first code and the second code are the same.

34. The method according to claim 30, further comprising:
receiving a first sidelink positioning reference signal resource reservation information indicating reservation of the one or more first resources for transmission of the one or more first sidelink positioning reference signals, wherein the request is transmitted after receiving the first sidelink positioning reference signal resource reservation information.

35. The method according to claim 30, wherein the reaction to the request message indicates whether use of at least part of the one or more first resources that are designated for the transmission of one or more first sidelink positioning reference signals for transmitting the second sidelink positioning reference signal is accepted.

36. The method according to claim 30, further comprising:
determining one or more physical sidelink feedback channel resources that are used for the reaction to the request message.

37. The method according to claim 30, wherein the reaction indicates that the requesting is denied if it corresponds to a denial response being transmitted and/or wherein the reaction indicates that the requesting is partly denied if it corresponds to a response being transmitted indicating a part of the one or more first resources for which use is denied and/or wherein the reaction indicates that the requesting is accepted if it corresponds to no response to the request message being transmitted in one or more resources that are used for the reaction to the request and/or wherein the reaction indicates that the requesting is accepted if it corresponds to an acceptance response being transmitted.

38. A non-transitory computer-readable medium storing instructions, the instructions when executed by a processor causing an apparatus to perform:
transmitting a request message requesting to use at least part of one or more first resources that are designated for transmission of one or more first sidelink positioning reference signals for transmitting a second sidelink positioning reference signal;
observing a reaction to the request message; and
determining, based on the observed reaction, whether use of the at least part of the one or more first resources is accepted for transmitting the second sidelink positioning reference signal.
